(19) United States
(12) Patent Application Publication
(10) Pub. No.: US 2018/0199546 A1
(43) Pub. Date: Jul. 19, 2018

(54) EMERGENCY RESPONSE PET COLLAR DEVICE

(71) Applicant: CHI HOME INSPECTIONS OF SF, LLC, West Palm Beach, FL (US)

(72) Inventor: Weston D. Temel, West Palm Beach, FL (US)

(21) Appl. No.: 15/872,364

(22) Filed: Jan. 16, 2018

Related U.S. Application Data
(60) Provisional application No. 62/446,956, filed on Jan. 17, 2017.

(51) Int. Cl. A01K 27/00; G08B 25/01; H04W 76/50

(52) U.S. Cl. CPC A01K 27/001; A01K 15/021; H04W 76/50; G08B 25/016

(57) ABSTRACT

The present invention discloses a wearable emergency alert device that can be worn by a pet or a service animal. The wearable emergency alert device comprises a single unit, which is integrated with a collar or body harness of a pet or service animal. The device includes a trigger to enable the system, as well as a global positioning system (GPS) beacon to identify the location of the unit once triggered. The device also includes a communicator system, which can operate over a cellular network, wireless network, or other similar network, to allow two-way communication from a user located near the device and a help desk operator.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/446,956, entitled “EMERGENCY RESPONSE PET COLLAR DEVICE”, filed Jan. 17, 2017. The contents of the above referenced application is incorporated herein by reference.

### FIELD OF THE INVENTION

This invention relates generally to the field of emergency alert devices and, in particular, to a pet-wearable emergency alert device capable of transmitting an emergency victim's location to a first responder or agency coordinating with a first responder.

### BACKGROUND OF THE INVENTION

Emergency alert devices have been used for decades to provide a measure of safety and security to persons, particularly to those persons who are likely to be in situations wherein they require assistance, or emergency assistance, but are otherwise unable to reach a telephone or other means of calling for help.

Emergency alert devices are especially popular with older people who, because of age or infirmities, are subject to falling or suffering strokes and heart attacks that can immobilize them. When immobilized, such persons are often not capable of accessing any nearby phones to telephone a care giver such as a friend, family member, or first responder.

Well known examples of such emergency alert devices include the “Life Alert” device manufactured by Life Alert Emergency Response, Inc. and the American Medical device that is distributed by American Medical Alarms, Inc.

Such devices are operated by using two separately encased and remotely positioned components. The first component comprises a portable wearable device that contains an emergency button and a radio transmitter. When the emergency button is activated by a user, a radio signal is sent to the second component that comprises a base unit. The base unit is usually placed at a fixed position in the dwelling, and is in communication with the land telephone line of the building in which the device is used. The portable wearable unit typically comprises a small pendant-sized unit that is coupled to a lanyard or rope, and worn like a pendant around the neck of the user. The base device is often sized similarly to a telephone base set, and is placed at a position in the house close to a telephone jack, so that it may connect through the phone jack into the land line circuitry of the house.

To operate the unit, a user depresses a button on the pendant/portable unit. The pendant/portable unit then sends a signal to the base unit. The base unit has an automatic dialing feature, which then communicates a signal through the land line of the house to a help desk maintained by a company, such as Life Alert or American Alarms, Inc. This information can be found at www.lifealert.com and www.americanmedicalalarms.com.

The normal protocol for dealing with such a call is that it is first received by a help desk operator, who attempts to communicate verbally with the user through a speaker phone feature on the base unit. This signal can also be programmed to be directed first to a remote care giver.

If the help desk operator, or remote care giver, can communicate with the user and establish that nothing is wrong with the user, or that a false signal has been sent, the care giver can terminate the telephone call knowing that the user is in no emergency. On the other hand, if the user is capable of verbally communicating with the help desk so that the care giver can determine the nature of the emergency, the help desk operator might be able to obtain enough information to contact the appropriate emergency responder, who may be a person, such as the next of kin, a closely located friend, an ambulance, a fireman, or a police agency.

Unfortunately, many times the help desk operator is not capable of determining the nature of the emergency. One cause for this inability is that the user may be too injured to communicate, or may be injured in a manner, such as having a stroke, wherein the user's ability to communicate is significantly compromised.

Other times, inability to communicate is related more to equipment issues than the patient's condition. In particular, when communication is conducted through a centralized speaker phone, the user's proximity to the particular position in the dwelling is determinative of the user's ability to communicate, i.e., if the user is far away from the base unit (which often occurs), the user is unable to communicate through the speaker phone with the help desk operator.

The company employing the help desk operator can employ various protocols to deal with the different situations a user can encounter, but the original emergency alert devices comprising a base unit with a speaker phone and a user worn pendant with a mobile trigger have drawbacks.

Though having a user carry a mobile phone would appear to be an ideal vehicle to eliminate these drawbacks, it also has its drawbacks. These drawbacks include that mobile phones rely primarily on batteries which are consumed at increasing rates. Although mobile phone technology continually improves power consumption rates, it is still risky for a user to rely on mobile phones to ensure their safety in an emergency. Further, it is not guaranteed that a user will possess their mobile phone on their person or be able to access it in the event of an emergency.

U.S. Pat. No. 8,249,547 to Fellner discloses a wearable emergency alert device that includes a wearable member and a separately encased mobile phone member that is selectively attachable to the wearable member. The wearable member includes an attachment member for attaching the wearable member to a body part of the user, a first transmitter for sending a first signal to the mobile phone member, a power source for the first transmitter and a first actuator operable by a user for actuating the first transmitter to send a signal to the mobile phone member. The mobile phone member includes a mobile phone transceiver for establishing a first communication link between the mobile phone transceiver and the first transmitter; and the second communication link between the mobile phone transceiver and a remote receiver for transmitting and receiving at least one of data, voice and messages between the mobile phone transceiver and a remote receiver. A mounting member is provided for selectively, removably mounting the mobile phone member to the wearable member, and permitting the mobile phone member to engage the first actuator to actuate an emergency signal.

www.LifeAlert.com discloses a “Life Alert Mobile” device to be used for emergencies away from home. The mobile design is disclosed as a pendant device that can be worn or carried in a bag or pocket, which can contact a dispatcher to send emergency help when an external button is pressed. The pendant allows a user to “be located by GPS anywhere in the United States where GSM cellular phones operate,” and that the battery will last up to 10 years without needing charging.

U.S. Patent Application Publication 2016/0071392 to Hankey et al. discloses that an occurrence of one or more “care events” is detected by an electronic device monitoring environmental data from one or more sensors. The electronic device transmits one or more alerts regarding the detected occurrence to at least one other electronic device. In some cases, the electronic device may cooperate with at least one other electronic device in monitoring, detecting, and/or transmitting. For example, the electronic device may detect the occurrence based on sensor data received from a cooperative electronic device, or such data in combination with the electronic device's sensor data. By way of another example, the electronic device may detect the occurrence and signal a cooperative electronic device to transmit one or more alerts.

U.S. Patent Application Publication 2009/0322513 to Hwang et al. discloses a medical emergency reporting system and methodology that utilizes a wearable monitoring device to continuously monitor key physiological parameters of a person; and when measurements exceed programmed threshold levels, it will automatically issue a medical emergency alert along with location information to a remote monitoring center via a wireless network and the Internet for immediate local response. This system will also provide manual emergency alert activation, continuous updates with key physiological measurements to the emergency response personnel, along with the medical history of the subject as well as redundancy in emergency alert reporting and malfunction diagnosis to assure ultimate accuracy, immediacy and reliability for the person that requires medical assistance.

U.S. Patent Application Publication 2014/0066000 to Butler discloses a mobile communication device which can be placed into an “attack detection mode.” While the device is in attack detection mode, certain events can cause the device to summon assistance automatically. For example, while the device is in attack detection mode, if the device's user ceases to interact with the device, then the device can automatically place a telephone call to emergency services (e.g., by calling 911). For another example, while the device is in attack detection mode, if an accelerometer contained within the device detects a sudden shock, then the device similarly can automatically place a telephone call to emergency services. After detecting a probable emergency situation, the mobile device can responsively and continuously emit a loud audible alarm through the device's speakers at a maximum volume regardless of the device's current silence or volume settings, in an effort to attract help from other people who may be nearby.

However, though recent technology has made it possible for a pendant sized unit to be able to function as both a trigger and communicator, it is common for users to forget, or actively choose not, to carry their pendant trigger on their person.

It is, therefore, beneficial for potential users of an emergency alert device to have an emergency alert device that will be with them without the user needing to carry the device on their person.

Because many users of emergency alert devices have pets or service animals which are with them at most times, it is beneficial to have a pet or service animal wearable mobile emergency alert device that will allow the pet or service animal to provide access to the emergency alert device for the user throughout the day. These pets or service animals will, additionally, be the most likely to quickly respond to any alert situation which the user encounters.

### SUMMARY OF THE INVENTION

The present invention, therefore, provides a wearable emergency alert device that can be worn by a pet or a service animal. The wearable emergency alert device comprises a single unit which is integrated with a collar or body harness of a pet or service animal. The device includes a trigger, to enable the system, as well as a global positioning system (GPS) beacon to identify the location of the unit once triggered. The device also includes a communicator system that can operate over a cellular network, wireless network, or other similar network, to allow two-way communication from a user located near the device and a help desk operator.

Accordingly, it is a primary objective of the instant invention to provide a pet-wearable emergency alert device that can be incorporated into a pet or service animal's collar or vest.

It is a further objective of the instant invention to provide an emergency alert device which provides the location of the user when activated.

It is yet another objective of the instant invention to provide an emergency alert device which will function for years without needing to change or charge batteries.

It is further an objective of the instant invention to provide a communication device for a user undergoing an emergency.

It is yet another additional objective of the instant invention to provide an emergency alert device which a user does not need to carry on their person.

Other objects and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of one embodiment of a pet wearable emergency alert device of the present invention; and

FIG. 2 is a schematic representation of the method by which the pet wearable emergency alert device can provide an emergency response in response to an emergency.

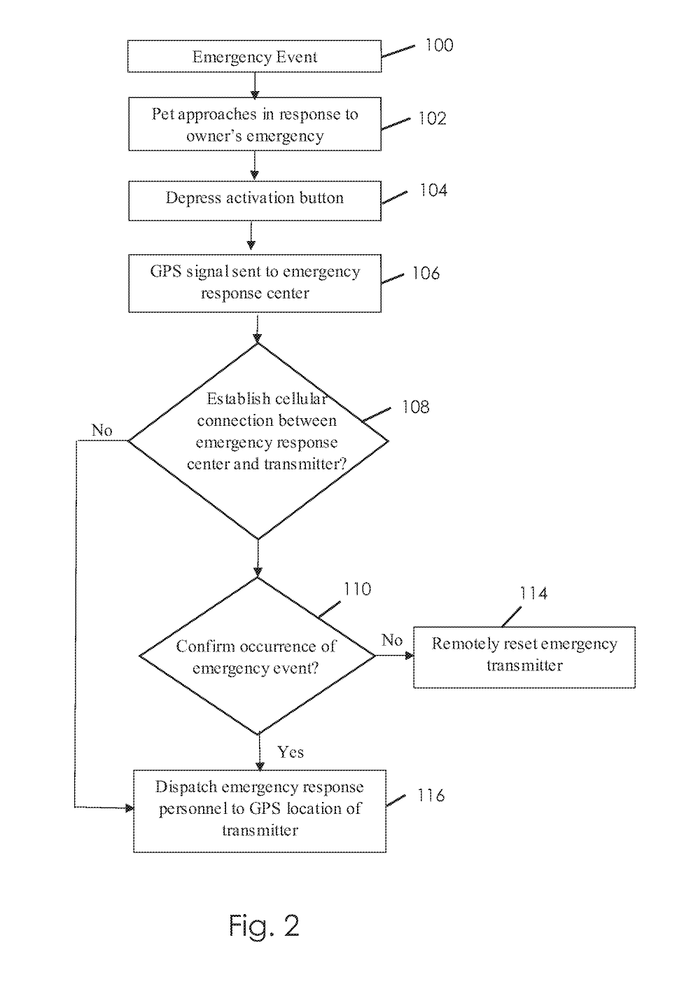

### DETAILED DESCRIPTION OF THE INVENTION

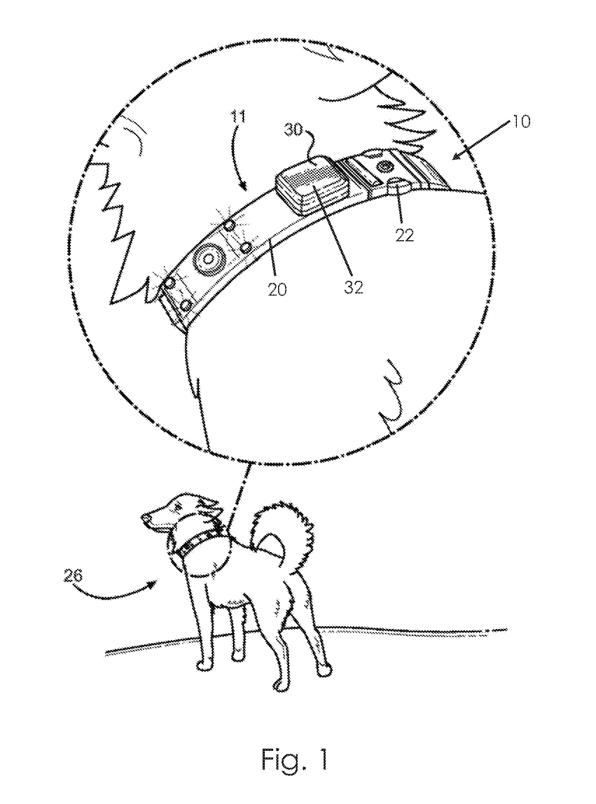

As shown in FIG. 1, a pet-wearable emergency alert device 10 includes a wearable member 11, such as a collar or a vest for a pet or service animal 26. A representative embodiment is for a dog on its collar. When employed on a pet collar, the emergency alert device is ever present with the pet while it is wearing its collar.

The wearable member includes an attachment portion 20 which wraps around the pet 26, as well as a fastener 22 to secure the wearable member 11 around the body of a pet or service animal 26. The attachment portion 20 of the wearable member can be a collar or body harness to be worn by the pet or service animal. Additionally, the attachment portion can be a saddle for use with other types of animals, such as a horse.

The attachment portion 20 can be a collar which wraps around the neck of the pet or service animal 26. The collar can be made of leather or a leather alternative, such as patent leather or bio-imitative leather. The collar can also be made of nylon or other synthetic materials commonly used for pet collars, such as polyester. It can be braided to add additional strength. Fabrics are another alternative for the collar material, or as a coating layer to add decoration to the collar.

The fastener 22 can be made from a belt-style buckle forged from brass, stainless steel or another durable metal. Plastic buckles can also be used, though they will not be as high quality. With a buckle, the collar will have a plurality of apertures to allow a prong to extend through to hold the size of the collar while attached.

Side-release or quick-release closures are commonly used as collar fasteners and can be made of durable metals like stainless steel or nickel alloy. Side-release plastic closures are also common and are very durable, and are usually used on fabric or synthetic collars to match the weight of the fabric. When side-release or quick-release closures are employed, a secondary adjustment clip (not shown) can be used to set the collar size to best fit the pet or service animal 26. Finally, the fastener 22 can be a slip knot, allowing the collar to tighten as a leash is pulled.

Not shown in the figure, but commonly included, is a D-ring to allow attachment of a leash to the collar. The D-ring can also be made of metal, such as stainless steel or nickel alloy, or plastic for weight savings. A second ring can also be employed so that a pet identification tag can be attached to the collar.

Alternatively, the attachment member 20 can be a vest that wraps around the torso of the pet so as not to choke the pet when a leash is pulled. Because more material would be used for the vest, the vest would more likely be made of fabric or synthetic material, such as nylon or polyester. The fastener 22 employed with a vest would be the same as one with a collar.

The wearable member 11 further includes a first transmitter 30. The first transmitter 30 can be permanently attached to the attachment portion 20, or removably secured so it can be replaced if necessary without replacing the wearable member 11.

The first transmitter 30 includes a button 32 on the outer portion of the transmitter body 34. The transmitter body 34 can be a multi-piece body to allow access into the interior of the unit, or a singular body to prevent inadvertent damage caused by accessing the interior of the unit by a person lacking skill in the technology employed by the transmitter 30.

Additionally, the body can be designed so that it can be added onto an already used collar or vest. In one embodiment, the body may have a clam-shell type opening, allowing a piece of material from the attachment portion 20 to pass through the interior of the body 34. Closing the body 34 around the material will allow the body 34 to securely attach to the attachment portion 20. Alternatively, the body 34 can have openings to allow the collar or vest to thread through a portion of the body 34. This would allow the transmitter 30 to be attached to an existing collar or vest without requiring the body 34 to be opened.

In an alternative embodiment, the transmitter 30 can be attached to the leash, instead of the attachment portion 20. This would allow for a person in an emergency situation to more readily access the transmitter button 32 to call for assistance.

The first transmitter 30 includes a GPS transmitter as well as a cellular network transmitter, which are electronically coupled to the button 32. A power source is included, such as a battery, to power the first transmitter. Further included in the transmitter are a speaker and a microphone, which are both electronically coupled to the cellular network transmitter.

When a user is in distress, such as during an emergency event 100, their pet or service animal are generally the first to notice that the user is in need of assistance and approach the owner to check on their safety 102. This allows the user to more easily access the emergency alert button located on the wearable member 11. Once a user depresses the button on the first transmitter 104, a GPS signal begins transmitting to an emergency response center 106 and attempts to establish cellular network connection between the first transmitter and the emergency response center 108. If a cellular connection is established, the emergency response center will confirm the occurrence of an emergency 110. If no emergency has occurred, such as if the button was accidentally or inadvertently depressed, the system can be remotely reset by the emergency center 114. The GPS signal will alert a help desk operator to locate the user, while the cellular network signal will enable the help desk operator to attempt to communicate with the user.

After the emergency alert device is activated, if a cellular connection can be established and the user is capable of verbal communication, the user will be able to seek assistance from the help desk operator and ask for the type of help the user requires, be it a care giver, family member, or emergency first responder. The emergency response center will then be able to dispatch emergency response personnel to the GPS location of the transmitter 116. The help desk operator will then be able to connect the user with the type of help required, by either connecting the cellular signal with the other party, or by relaying the location and distress to the third party. Similarly, if a cellular connection cannot be established, a response team will be dispatched to the GPS location of the transmitter 116.

If the user is unable to verbally communicate, the help desk operator will then be able to follow protocols designated by the user to alert assistance to the user's location based on the GPS signal. This will allow the help desk operator to alert the necessary responder so as to assist the user undergoing an emergency.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A wearable emergency alert device, comprising:
an attachment member, said attachment member constructed and arranged to attach to the body of an animal;
a fastener coupled to said attachment member, said fastener constructed and arranged to fasten said attachment member to itself to retain said attachment member around the body of an animal; and
a first transmitter coupled to said attachment member, said first transmitter having an activation button and a power source, whereby said first transmitter is constructed and arranged to broadcast a GPS alert upon activation of said activation button.

2. The wearable emergency alert device of claim 1, wherein said attachment member is a collar.

3. The wearable emergency alert device of claim 1, wherein said attachment member is a harness.

4. The wearable emergency alert device of claim 1, wherein said attachment member is a vest.

5. The wearable emergency alert device of claim 1, wherein said attachment member is a saddle.

6. The wearable emergency alert device of claim 1, wherein said fastener is a buckle.

7. The wearable emergency alert device of claim 1, wherein said fastener is a side release closure.

8. The wearable emergency alert device of claim 7, further comprising a secondary adjustment clip coupled to said attachment member, said secondary adjustment clip constructed and arranged to allow said attachment member to size to be adjustable.

9. The wearable emergency alert device of claim 1, wherein said fastener is a slip knot.

10. The wearable emergency alert device of claim 1, further comprising a primary ring coupled to said attachment member, said primary ring constructed and arranged to be coupled to a leash.

11. The wearable emergency alert device of claim 10, further comprising a secondary ring coupled to said attachment member, said secondary ring constructed and arranged to be coupled to an identification tag.

12. The wearable emergency alert device of claim 1, wherein said first transmitter includes an activation button.

13. The wearable emergency alert device of claim 12, wherein said first transmitter includes a GPS transmitter, said first transmitter transmitting a GPS signal to an emergency response center upon activation of said activation button.

14. The wearable emergency alert device of claim 13, wherein said first transmitter includes a cellular network transmitter, said first transmitter cellularly connecting to an emergency response center upon activation of said activation button.

15. A method of seeking help in an emergency situation comprising the steps of:
activating an activation button on a pet wearable emergency alert device;
transmitting a GPS signal to an emergency response person; and
dispatching an emergency response to the location of said pet wearable emergency alert device.

16. The method of seeking help in an emergency situation of claim 15, further comprising: attempting to establish a cellular connection between said pet wearable emergency alert device and said emergency response person.

17. The method of seeking help in an emergency situation of claim 16, wherein said emergency alert person is a help desk operator.

18. The method of seeking help in an emergency situation of claim 17, further comprising: determining the appropriate response.

19. The method of seeking help in an emergency situation of claim 16, further comprising: confirming the occurrence of an emergency event.
